(19) United States
(12) Patent Application Publication
(10) Pub. No.: US 2024/0046649 A1
(43) Pub. Date: Feb. 8, 2024

(54) SYSTEM THAT DETERMINES SHELF CONTENTS FROM IMAGES PROJECTED TO THE TOP OF ITEMS

(71) Applicant: ACCEL ROBOTICS CORPORATION, San Diego, CA (US)

(72) Inventors: Marius BUIBAS, San Diego, CA (US); John QUINN, San Diego, CA (US)

(73) Assignee: ACCEL ROBOTICS CORPORATION, San Diego, CA (US)

(21) Appl. No.: 17/880,842

(22) Filed: Aug. 4, 2022

Related U.S. Application Data
(63) Continuation-in-part of application No. 17/879,726, filed on Aug. 2, 2022.

(51) Int. Cl. G06V 20/52; G06V 10/12; G06V 10/82; G06V 10/40; G06V 10/774; G06V 10/25

(52) U.S. Cl. CPC G06V 20/52; G06V 10/12; G06V 10/82; G06V 10/40; G06V 10/774; G06V 10/25

(57) ABSTRACT

A system that determines the items on a shelf by projecting camera images to a surface aligned with the tops of the items. Projecting the images to the top surface removes distortions due to camera projections and aligns multiple images to a common reference frame. Item tops may be visible without occlusion in one or more camera images, simplifying item identification. The projected images may be input into an item detector that is trained to recognize images of the tops of items. The item detector may process projected images from different cameras with parallel feature extractor subnetworks that generate feature maps; the feature maps may then be averaged across images and the averaged feature map may be input into an item detection subnetwork.

This application is a continuation-in-part of U.S. Utility patent application Ser. No. 17/879,726, filed 2 Aug. 2022, the specification of which is hereby incorporated herein by reference.

### BACKGROUND OF THE INVENTION

### Field of the Invention

One or more embodiments of the invention are related to the field of image analysis. More particularly, but not by way of limitation, one or more embodiments of the invention enable a system that determines shelf contents from images projected to the top of items.

### Description of the Related Art

Organizations that stock or sell items often need to determine the current contents of each shelf. This information may be used to manage inventory, to plan placement or rearrangement of items on shelves, and to manage shelf restocking. Typically, this information is determined by performing a manual inventory of the items on each shelf, which is an extremely time-consuming and error-prone process.

In some environments, shelves may be monitored continuously or periodically by cameras. For example, in an automated store or in a fully or partially automated warehouse, cameras may be used to detect when items are taken from or added to shelves. Camera images of shelves may be used in principle to determine the shelf contents. However, analysis of these images is complicated by factors such as spatial distortions due to camera perspectives and occlusion items by the other items on the shelf. There are no known systems that process shelf images to compensate for these effects.

For at least the limitations described above there is a need for a system that determines shelf contents from images projected to the top of items.

### BRIEF SUMMARY OF THE INVENTION

One or more embodiments described in the specification are related to a system that determines shelf contents from images projected to the top of items. The system may have a processor and a memory connected to the processor. The processor may be coupled to multiple cameras that are each oriented to view a shelf that contains one or more items selected from a set of multiple items. The memory may contain a top surface projection transformation associated with each camera that maps images from the camera to a top surface above the surface of the shelf, where the top surface is substantially aligned with the tops of the items on the shelf. The processor may be configured to obtain shelf images form the camera, projected these shelf images onto the top surface using the top surface projection transformations, input the projected shelf images into an item detector configured to analyze images and identify instances of items whose tops appear in the images, and calculate the contents of the shelf from the output of the item detector.

In one or more embodiments the item detector may include a neural network with identical copies of a feature extraction network, each of which receives an input of one of the projected shelf images. The feature extraction networks may be connected to an averaging block, and the output of the averaging block may be connected to an item detection network.

In one or more embodiments the neural network may be trained based on labelled images, each of which has a training image, one or more regions of interest that each surround an image of the top of a corresponding item, and an item identity associated with each region of interest.

In one or more embodiments the top surface may contain a plane substantially parallel to the surface of the shelf. The top surface projection transformation associated with each camera may include a homography between the image plane of the camera and the top plane.

### BRIEF DESCRIPTION OF THE DRAWINGS

The above and other aspects, features and advantages of the invention will be more apparent from the following more particular description thereof, presented in conjunction with the following drawings wherein:

FIG. 1 shows an overview diagram of an illustrative embodiment of the invention, which analyzes images of a shelf taken from different viewpoints to determine the identities and quantities of items on the shelf.

FIG. 2 shows a flowchart of illustrative steps performed by a processor to obtain and analyze images to calculate shelf contents.

FIG. 3 shows illustrative camera images of the shelf of FIG. 1.

FIG. 4 illustrates transformations that map camera images onto a plane aligned with the tops of the items on the shelf.

FIG. 5 illustrates projection of the camera images of FIG. 3 onto the top plane.

FIG. 6 illustrates analyzing the projected images of FIG. 5 using an item detector neural network and determining the contents of the shelf from the output of this detector.

FIG. 7 illustrates training of the neural network of FIG. 6 using labelled projected images containing the tops of items.

### DETAILED DESCRIPTION OF THE INVENTION

A system that determines shelf contents from images projected to the top of items will now be described. In the following exemplary description, numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

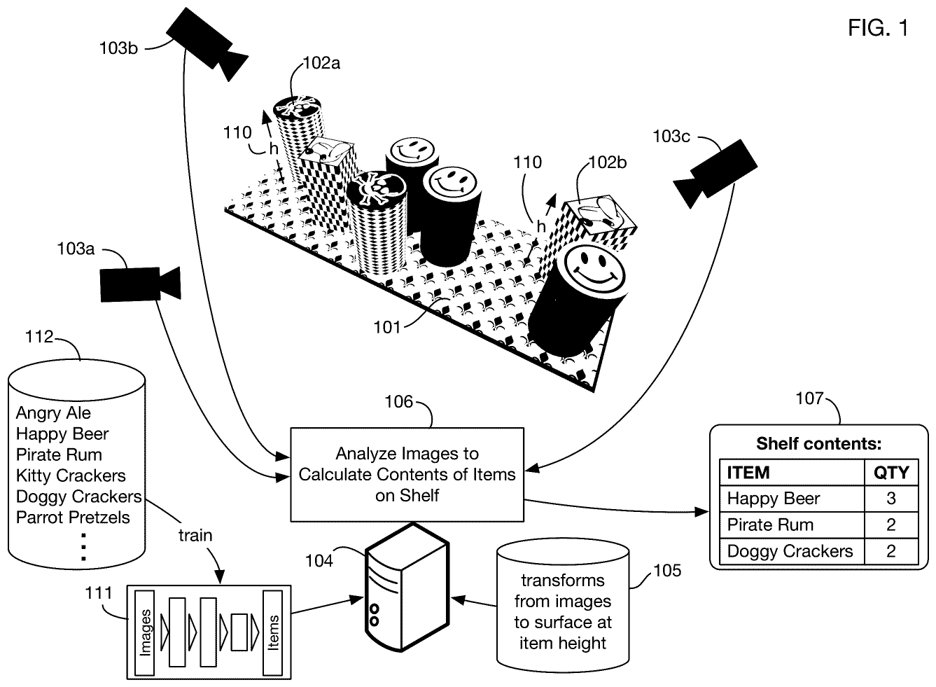

FIG. 1 shows an illustrative embodiment of the invention that determines the contents of shelf 101 based on images of the shelf captured from multiple cameras. A “shelf” in this application may be any fixture, zone, device, area, case, furniture, container, or similar element that may be used to hold, support, display, or contain one or more items. The items on the shelf may be selected from a known set of items 112, such as a set of SKUs available in a store. For each of these items, the shelf may contain zero, one, or multiple instances of the item.

The illustrative embodiment shown in FIG. 1 determines which items are on shelf 101, and in what quantities, based on analysis of images of the shelf and the contained items captured by cameras 103a, 103b, and 103c. One or more embodiments of the invention may analyze images from any number of cameras to determine the contents of the shelf. Cameras may be oriented to view the shelf from various positions and orientations. Cameras may be integrated into a shelving system, or they may be placed outside the shelf. Any image from any camera that views at least a portion of the shelf or a portion of the shelf's contents may be used in one or more embodiments of the invention.

Analysis 106 of camera images to determine the contents of the shelf 107 may be performed by a processor 104, or by multiple processors. Processor or processors 104 may be for example, without limitation, a desktop computer, a laptop computer, a notebook computer, a server, a CPU, a GPU, a tablet, a smart phone, an ASIC, or a network of any of these devices. The processor may receive or obtain camera images of shelf 101 from cameras 103a, 103b, and 103c and may perform analyses 106, as describe in detail below, to calculate shelf contents 107.

In one or more embodiments, the items on the shelf may have substantially similar heights. For example, illustrative items 102a and 102b on shelf 101 both have approximately height 110. In this situation it may be advantageous to analyze camera images by projecting these images onto a top surface at this item height, and then inputting the projected images into an item detector 111. The detector 111 may be trained for example on projected images of the full set of items 112 that could be on the shelf. Transformations to project from camera images onto the top surface, or data related to these transformations, may be stored in memory 105 that is coupled to processor 104. A benefit of analyzing the projected images instead of the raw images captured by the cameras is that the tops of the items may be distorted in the raw image, but the projection onto the top surface may remove this distortion, simplifying item recognition. The tops of items are less likely to be occluded by other items, so recognizing items based on the appearance of their tops may also be more reliable when the shelf contains multiple items.

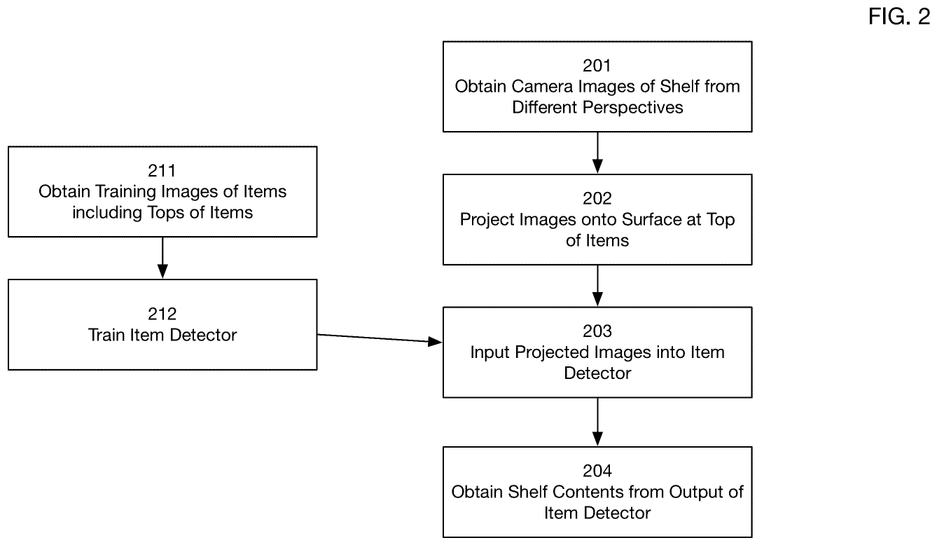

FIG. 2 shows an illustrative sequence of steps that may be performed in one or more embodiments to calculate shelf contents from camera images. These steps may be performed for example by processor or processors 104. One or more embodiments may perform a subset of these steps, may reorder steps, or may perform any additional steps. In step 201, the processor obtains camera images of the shelf from various cameras that can view the shelf and its contained items from different perspectives. Any number of camera images may be obtained. Some of the camera images may capture only a portion of the shelf. In step 202, the camera images are projected onto the top surface aligned with the tops of items, so that the projected images are aligned to a common reference frame and so that perspective distortions are removed. In step 203, the projected images are input into an item detector that has detects the locations and identities of items in the projected images. In step 204, the shelf contents, which includes item identities and quantities, is calculated from the output of the item detector.

In one or more embodiments the item detector may be trained before it is used to detect items on a shelf. Illustrative training steps that may be performed include step 211 to obtain training images of the set of items that may be on the shelf, and step 212 to train the item detector using these images. The training images may include the tops of the set of set of items to be detected. Steps 211 and 212 may be performed by any processor or processors, which may be the same as or different from the processor or processors that perform steps 201 through 204.

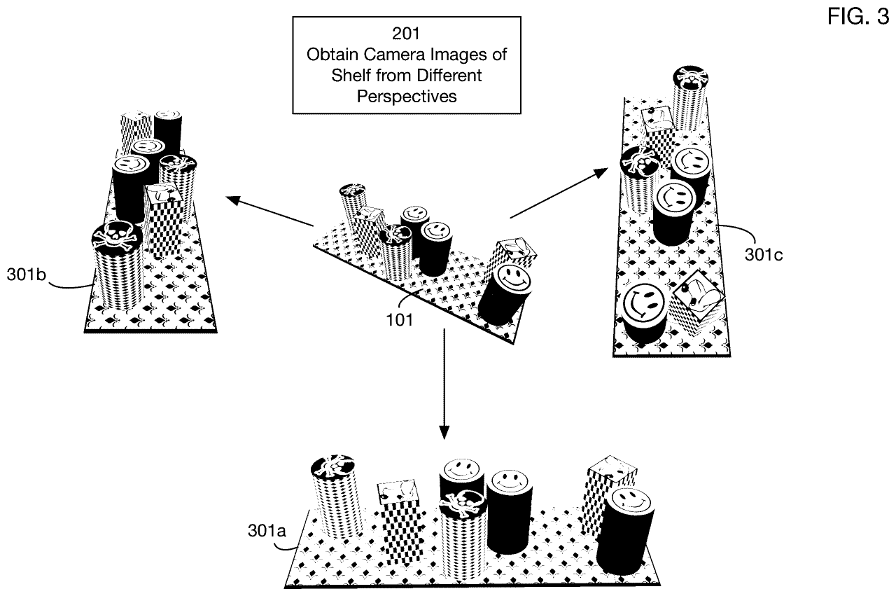

FIGS. 3 through 6 illustrate the steps 201 through 204 for the illustrative shelf 101 of FIG. 1. FIG. 3 illustrates the initial step 201 of obtaining camera images 301a, 301b and 301c of the shelf from different viewpoints corresponding to the three cameras 103a, 103b, and 103c. In this example, each image contains a view of the entire shelf; in some embodiments, camera images may view only a portion of the shelf.

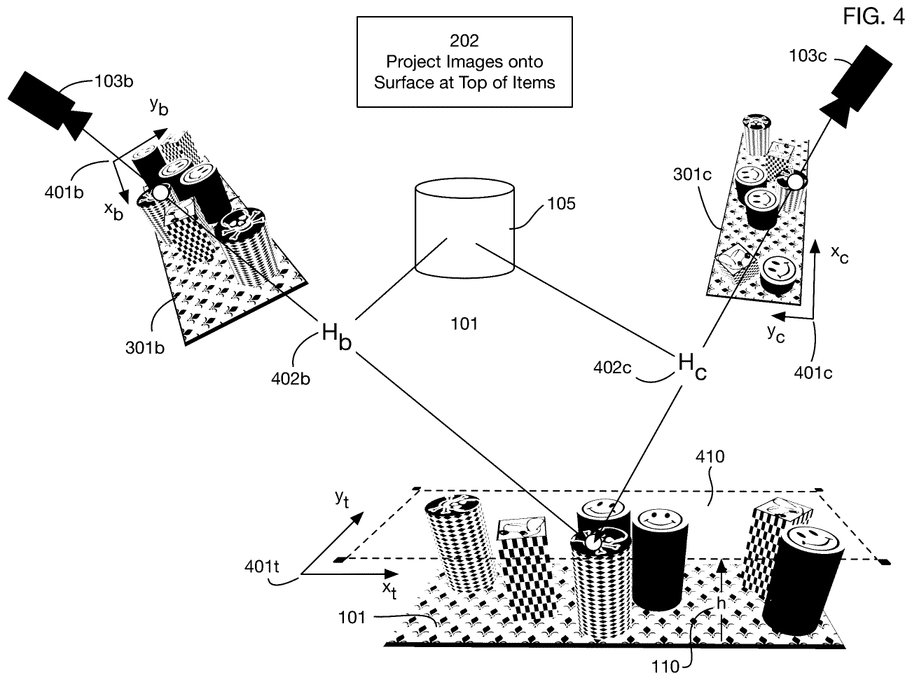

Because camera images 301a, 301b, and 301c are subject to perspective effects and other potential distortions, detection of items directly in these images may be difficult. To remove perspective effects and other distortions, images may be reprojected onto the top surface 410 aligned with the tops of items, as illustrated in FIG. 4 for images 301b and 301c. Projecting images onto this surface 410 recovers the undistorted appearance of the item tops (although the sides of the items may still be distorted). In the illustrative example of FIG. 4, top surface 410 is a plane that is parallel to the surface of shelf 110. This plane 410 is elevated above the shelf surface at height 110, corresponding to the approximate height of the items on the shelf. The top surface need not be planar; it may be any surface that approximately aligns with the expected position of the tops of items on the shelf.

Transformation 402b may map points in image reference frame 401b into corresponding points in top surface reference frame 401t. Similarly, transformation 402c maps points in image reference frame 401c into top surface reference frame 401t. If top surface 410 is planar, and if the camera images are simple perspective images without other lens distortions, then these mappings 402b and 402c are homographies. However, any linear or nonlinear transformations may be defined and stored in database 105 for any type of top surface, including curved surfaces, and for any type of camera imaging projections. In one or more embodiments the transformations 402b and 402c may be calculated as needed during image analysis, rather than being stored directly in database 105; the database or another memory may include any required camera parameters and top surface descriptors to derive the appropriate transformations.

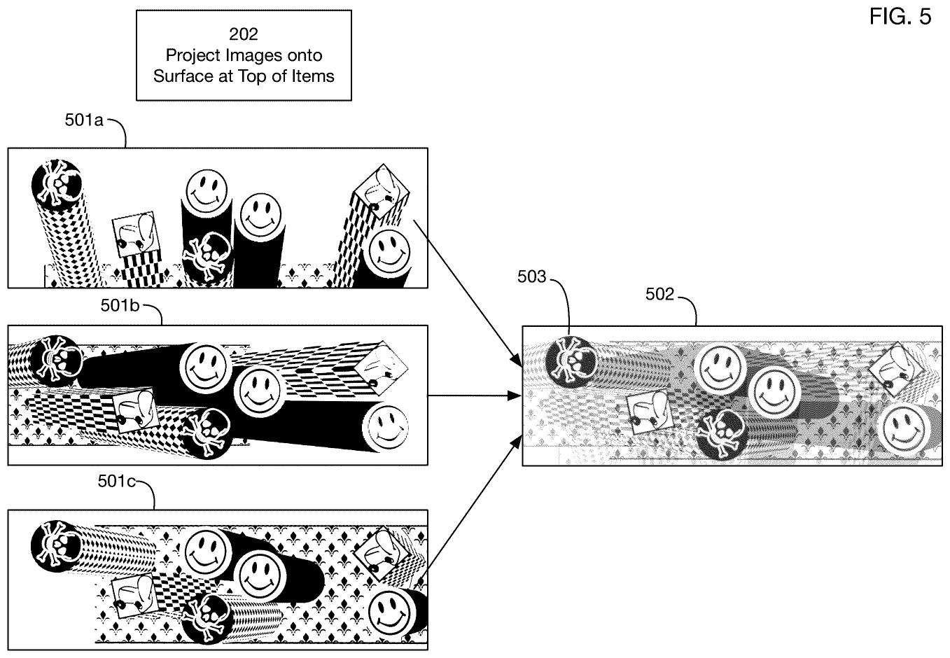

FIG. 5 shows the results of step 202 to apply the top surface projection transformations to the camera images 301a through 301c. The resulting projected images 501a through 501c are aligned on a common top surface reference frame 401t. The tops of the items on the shelf therefore appear in the same locations in each of the projected images 501a through 501c. This is illustrated in combined image 502, which overlays the images 501a through 501c on top of one another; the item tops coincide in the overlaid images. This alignment of item tops in projected images may be exploited by the item detector, as described below, by combining detected features at the same locations across the projected images.

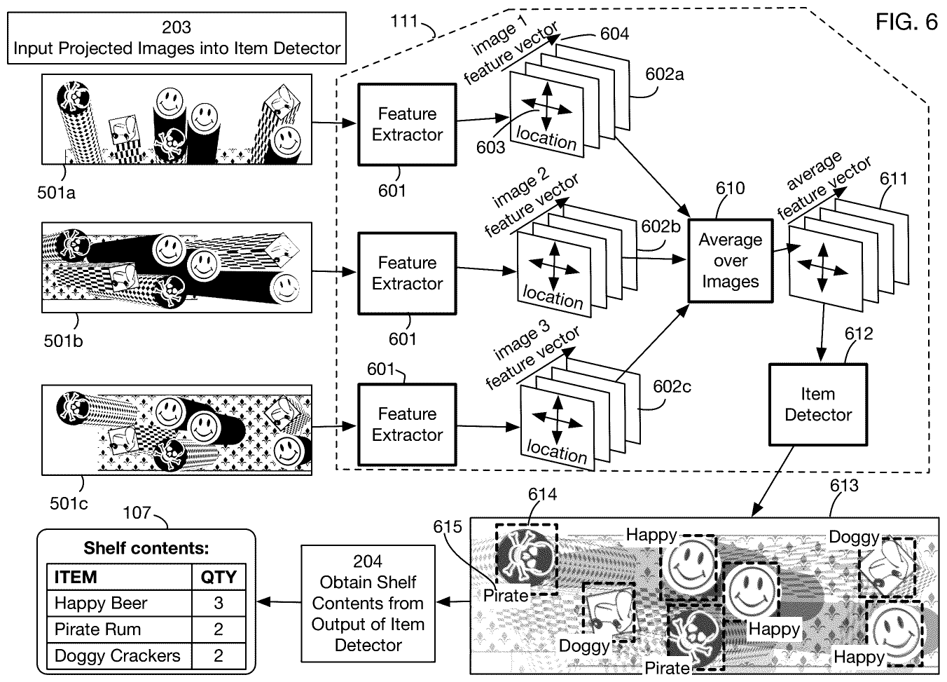

FIG. 6 illustrates detection of items in the projected images 501a through 501c. The projected images may be input into an item detector 111 that analyzes the images and outputs a map 613 with the location of detected items (shown as regions of interest surrounded by dotted lines) and the identity of each detected item (shown as a label on the region of interest). For example, item detector 111 detects an item at location 614 and determines that its type is 615. Because the images 501a through 501c are projected onto the top surface aligned with item tops, the detector 111 may detect items by searching for regions that match the expected appearance of the tops of items. Step 204 then processes this output 613 to generate an inventory 107 of the contents of the shelf, with the identities and quantities of the items on the shelf.

FIG. 6 shows an illustrative internal structure for item detector 111. One or more embodiments may use an item detector of any desired type and architecture; the structure described with respect to FIG. 6 is illustrative. This item detector is a neural network, which may be similar for example to RetinaNet, for example. It may perform detection using a first stage of a feature extraction subnetwork, and a second stage of an item detector subnetwork 612 that maps features into output 613. RetinaNet and similar detectors typically operate on a single image. Because one or more embodiments of the invention obtain multiple projected images from different cameras, the basic architecture of feature extraction followed by item detection may be modified to use parallel identical copies of feature extractor 601, each of which is applied to one of the projected images. In the example of FIG. 6, there are three projected images 501a through 501c, so there are three parallel copies of feature extraction subnetwork 601. Each feature extractor subnetwork may output a feature map with values for a feature vector at various locations within the corresponding image. (Locations may correspond for example to pixel addresses or to addresses of higher order regions or blocks within the image.) For example, feature extractor 601 applied to projected image 501a generates feature map 602a; this map 602 may be viewed as a three-dimensional array with two dimensions 603 corresponding to location within the image, and the third dimension 604 corresponding to components of the feature vector. Similarly applying feature extractor 601 to projected images 501b and 501c generates feature maps 602b and 602c, respectively. These parallel branches are then combined with an averaging block 610, which averages the feature vector values across images at each location, resulting in combined feature map 611. This averaging is sound because the tops of the items are aligned at the same locations in images 501a through 501c. The average feature map 611 is then input into item detector 612.

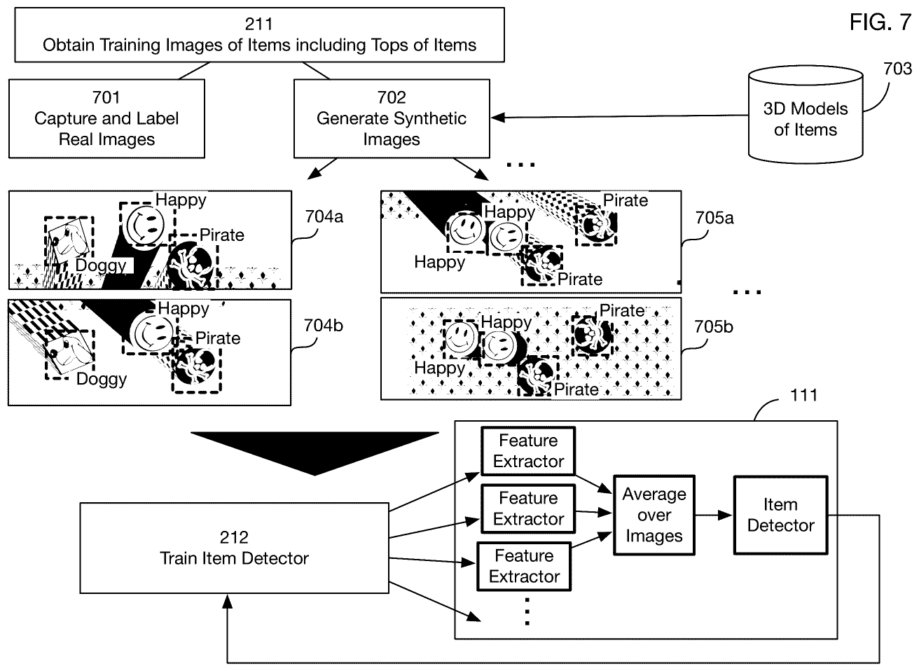

FIG. 7 illustrates steps 211 and 212 of training item detector 111. Step 211 obtains or generates training images of items. These images are generally labelled with the expected outputs, which may include the regions of interest surrounding items and the identities of the items. Training images may be obtained using process 701 of capturing, projecting, and labelling actual images of items on a shelf, or using process 702 of generating synthetic images based on information 703 about the items. The item information 703 may for example include 3D models of the items' shapes and appearances. Training images may be captured or generated for various combinations of items on shelves, and from various camera perspectives. Illustrative training images 704a and 704b show two camera views of three different items (each projected to the top plane) and illustrative training images 705a and 705b show two camera views of two instances each of two different items. In practice many thousands or millions of training images may be used. These labelled images are input into process 212 to train the item detector 111.

While the invention herein disclosed has been described by means of specific embodiments and applications thereof, numerous modifications and variations could be made thereto by those skilled in the art without departing from the scope of the invention set forth in the claims.

What is claimed is:

1. A system that determines shelf contents from images projected to the top of items, comprising:
a processor coupled to a plurality of cameras oriented to view a shelf configured to contain one or more items selected from a plurality of items; and,
a memory coupled to said processor, wherein said memory contains a top surface projection transformation associated with each camera of said plurality of cameras that maps images from said each camera to a top surface above a surface of said shelf, wherein said top surface is substantially aligned with tops of said one or more items;
wherein said processor is configured to obtain shelf images from said plurality of cameras;
project said shelf images onto said top surface to form projected shelf images, using said top surface projection transformation associated with each camera of said plurality of cameras;
input said projected shelf images into an item detector configured to analyze images and identify instances of said plurality of items whose tops appear in said images; and,
calculate contents of said shelf from an output of said item detector.

2. The system that determines shelf contents from images projected to the top of items of claim 1, wherein said item detector comprises a neural network comprising identical copies of a feature extraction network, wherein each projected shelf image of said projected shelf images is input into a copy of said identical copies of said feature extraction network;
an averaging block coupled to said identical copies of said feature extraction network; and,
an item detection network coupled to said averaging block.

3. The system that determines shelf contents from images projected to the top of items of claim 2, wherein said neural network is trained based on labelled images, each labelled image of said labelled images comprising
a training image;
one or more regions of interest in said training image, wherein each region of interest of said one or more regions of interest surrounds an image of a top of a corresponding item of said plurality of items; and,
an item identity associated with each region of interest.

4. The system that determines shelf contents from images projected to the top of items of claim 1, wherein said top surface comprises a plane substantially parallel to said surface of said shelf.

5. The system that determines shelf contents from images projected to the top of items of claim 4, wherein said top surface projection transformation associated with each camera comprises a homography between an image plane of said each camera and said plane substantially parallel to said surface of said shelf.
